(19) United States
(12) Patent Application Publication
(10) Pub. No.: US 2024/0221972 A1
(43) Pub. Date: Jul. 4, 2024

(54) CHARGING CABLE WITH OPTIMIZED MANAGEABILITY

(71) Applicant: COROPLAST FRITZ MÜLLER GMBH & CO. KG, Wuppertal (DE)

(72) Inventors: Kristian DIECKERHOFF, Sprockhövel (DE); Oliver BRAMBACH, Sprockhövel (DE); Helmut WICHMANN, Dülmen (DE)

(21) Appl. No.: 18/574,603

(22) PCT Filed: Jun. 20, 2022
(86) PCT No.: PCT/EP2022/066742

§ 371 Date: Dec. 27, 2023

(30) Foreign Application Priority Data
Jul. 1, 2021 (EP) 21183089.8

(51) Int. Cl. H01B 7/02; B60L 53/18; H01B 3/30; H01B 3/44; H01B 7/08; H01B 7/18

(52) U.S. Cl. CPC H01B 7/0233; B60L 53/18; H01B 3/302; H01B 3/441; H01B 7/0225; H01B 7/0275; H01B 7/0823; H01B 7/187

(57) ABSTRACT

An electrical charging cable for connecting a charging station to an electric vehicle. The electrical charging cable including an electrical insulating sheath of a plastic material and at least three wires arranged in the sheath, each having at least one electrical conductor, wherein the sheath has at least one foamed layer. A maximum width of the charging cable is formed larger in a first extension direction extending perpendicular to the cable axis than a maximum height in a second extension direction extending perpendicular to the first extension direction and to the cable axis. An assembled electrical charging cable is formed of such a charging cable and at least one plug-in coupling part electrically connected to the charging cable at at least one end for releasable electrical connection of the charging cable to a compatible plug-in coupling part of an electric vehicle.

### BACKGROUND

The invention relates to an electrical charging cable for connecting a charging station to an electric vehicle, comprising an electrically insulating sheath consisting of a plastic material and at least three wires arranged in the sheath, each comprising at least one electrical conductor and an insulating layer, wherein the sheath comprises at least one foamed layer. In addition, the invention comprises an assembled electrical charging cable with such a charging cable and at least one plug-in coupling part.

Electrical cables with a foamed sheath layer are known, for example, from EP 2 329 503 A1. The specific mass of these cables is relatively low. In addition, stripping is made easier when manufacturing the cable over larger and oversized cable lengths and the torsional behavior is improved as well as the mechanical pressure resistance and flexural fatigue strength due to the damping effect of the foamed layer.

The charging cables must comply with various standards and norms. These include in particular the IEC 62893-1 and -3 Edition 1.0 standard from November 2017 and DIN EN 50620 from March 2020 for charging cables for electric vehicles, which specify various requirements for the structure, material, thickness, mechanical properties, insulation properties, flame resistance, electrical resistance, resistance to chemicals and weather/UV resistance. In particular, the number of wires, the wall thickness of the insulating sheath and the outer dimensions of the cable also play an important role.

In addition, such charging cables must be designed for a maximum operating voltage of up to and including 480 V (conductor—ground) or 825 V (conductor—conductor). At the same time, the maximum operating temperature at the conductors must not exceed 90° C. In addition, the sheathing of the charging cable in particular must ensure that the temperature at the charging cable surface does not exceed 80° C. or, if skin contact of the user with the charging cable surface cannot be ruled out, that the temperature at the charging cable surface does not exceed 50° C. In addition, the temperature must not exceed 40° C. when the charging cable is stored.

The Chinese standard GB/T 33594-2017 dated May 12, 2017 should also be mentioned, which also specifies certain requirements, for example for the structure, material, thickness, insulation properties and flame retardancy.

Another electrical charging cable for an electric vehicle is known from CN 203311878 U. In this charging cable, glass fibers are inserted into an inner layer of the electrical insulating sheath. In addition, a layer for electromagnetic shielding is arranged in the sheath. The individual wires are arranged at a distance from each other in the inner layer. With a charging cable of this type, the installation space of the charging cable is relatively large and the charging cable is relatively heavy.

Due to the previous design, known charging cables have the disadvantage that their manageability is relatively bad, as they can twist relatively often due to their flexibility and thus become knotted. In addition, when the charging cable is wound up, the layers do not lie securely on top of each other. This causes problems in particular if these charging cables are to be stowed in the electric vehicle by the driver or wound up and stored at a charging station.

In addition, the requirements for the maximum temperature of the charging cable surface are particularly difficult to observe, especially due to the high charging power required combined with the expected weight savings.

### SUMMARY

The invention is based on the problem of providing a charging cable that complies with the normative requirements and at the same time improves manageability and reduces the temperature at the charging cable surface.

According to the invention, the problem is solved by the features of the characterizing part of claim 1. By forming a maximum width of the charging cable in a first extension direction perpendicular to the cable axis larger than a maximum height in a second extension direction perpendicular to the first extension direction and to the cable axis, a preferred bending direction around the thinner side of the charging cable is generated. This prevents the charging cable from twisting in different directions and makes it more difficult to get knots in the cable. This also makes it easier to wind up the cable and therefore to store the cable in a storage space in the electric vehicle or in a storage container in the charging station. This also enables an increased sheath surface, in particular with a comparable minimum wall thickness, i.e. with a comparable minimum distance between the outer surface of the wires and the outer surface of the sheath. As a result, the thermal energy on the charging cable surface can be dissipated better. In addition, this enables a larger distance between the energy wires relative to one another, whereby the thermal energy can be better distributed in the charging cable, so that the thermal energy can be dissipated more efficiently via the charging cable surface.

Advantageously, the sheath comprises at least two layers, an outer layer and an inner layer surrounded by the outer layer, wherein the foamed layer forms the outer layer and/or the inner layer. In particular, the foamed layer forms the inner layer.

In a preferred embodiment comprising at least two foamed layers, two of the foamed layers comprise a different specific density, wherein the difference in specific density of the foamed layers is at least 5%, preferably at least 10%. This enables an optimum balancing of weight savings, tensile strength, elongation at break and other normative and technical requirements, such as wall thickness.

Preferably, the foamed layer directly surrounds an outer insulation layer of the wires, so that in particular no additional release additives or sliding layers are required for improved separability between the foamed layer and the insulation layer of the wires.

Preferably, the maximum width of the charging cable in the first extension direction is at least 1.5 times larger than the maximum height in the second extension direction. Reducing the height on one side of the charging cable also results in smaller bending radii over the thinner side. Due to the reduced bending radius, the charging cable can be wound up to a smaller radius over the thinner side. The wider side increases stability when the layers are wound up on top of each other.

The maximum width in the first extension direction is between 10 mm and 22 mm, depending on the wire cross-section. The maximum height in the second extension direction is between 4 mm and 12 mm, depending on the wire cross-section.

By reducing the height on one side and thus creating a thinner side, the packaging dimensions can be reduced by rolling up the charging cable compared to a round charging cable.

Due to the lower bending capacity of the charging cable over the wider side, the charging cable can be optimally guided into the automatic assembly machine. The flat arrangement of the elements means that they always remain in the same position in the charging cable and are therefore easier to locate and process in the assembly process. As the individual elements do not require a separating aid, there are no additional work steps and the system is not contaminated by dusty particles.

Of the wires in the charging cable, at least three wires are used to transmit a charging current as so-called energy wires. Preferably, at least one core is used for data or signal transmission between the charging station and the electric vehicle as a so-called pilot core. In a preferred embodiment, the charging cable has three energy cores and one pilot core, in particular two pilot cores. In an alternative preferred embodiment, the charging cable has five energy cores and up to five pilot cores. Preferably, the charging cable has at least one, preferably two pilot cores.

Preferably, the energy cores and/or the pilot cores each comprise several metallic cores, in particular consisting of copper, aluminum and/or metal alloys, for electrical transmission. The energy wires and/or the pilot wires comprise their own electrical insulation layer.

The energy wires of a charging cable are thicker in cross-section than the pilot wires of a charging cable. In particular, the energy cores have an average cross-section of 1.5 mm² to 50 mm², preferably 2.5 mm² to 6 mm². In particular, the pilot cores 14 have an average cross-section of 0.088 mm² to 1.5 mm², preferably 0.5 mm² to 0.75 mm².

The outer layer and/or the foamed layer consist in particular of thermoplastic polyurethane elastomers (TPU), which as semicrystalline materials belong to the class of thermoplastic elastomers. They are high-performance materials whose properties combine dynamic load-bearing capacity, high flexibility over a wide temperature range, high wear resistance as well as buckling and tear resistance (tear and tear propagation resistance) with good resistance to the influence of oil, grease and solvents, weathering, ozone and UV radiation, as well as hydrolytically active substances and microbes. They are re-meltable and can therefore be easily recycled.

Preferably, the foamed layer in particular is formed in such a way that the thermal conductivity of the outer sheath is reduced by the foam structure. The temperature load caused by current loads on the energy wires is thermally insulated by the foamed sheath structure. The resulting sheath surface temperature is lower compared to solid sheath material layers.

A combination of foamed layer and flat design is particularly advantageous for reduced heating of the charging cable surface.

The use of foamed layers reduces the weight of the charging cable due to the lower density of the material.

In particular, the outer layer comprises two opposite straight regions extending in the first extension direction, each of which is connected at the ends to the opposite end of the other straight region via an annular region.

In an advantageous embodiment, the outer layer alternatively has several arcuate, adjoining partial regions in the first extension direction along the thinner side of the charging cable, the respective radius of curvature of which is aligned with the outer diameter of the wire arranged in the respective partial region, so that the outer layer runs parallel to the outer circumference of the respective wire, particularly in the respective partial region. This results in a contoured sheath surface, which reduces superfluous material and reduces the operational weight of the sheath to what is necessary. The contoured sheath surface also increases the sheath surface area, which improves heat dissipation. The charging cable receives additional cooling. The contact surface of the sprayed elements, such as plugs and grommets, with the sheath is also increased. The sprayed material can thus establish a connection to the sheath on the larger contact surface and achieve an increased seal. In particular, the outer layer comprises an average wall thickness of 0.5 mm to 2.5 mm.

Advantageously, the wires run parallel to one another in the first extension direction and are arranged in cross-section after the other in a single row. In particular, the pilot wire(s) is/are arranged in the cross-section in clearances between the energy wires arranged in a row.

In an advantageous embodiment, the wires, together with preferably existing pilot wires, are divided into two wire groups, in particular stranded separately from one another, wherein the wire groups run parallel to one another and are arranged in the cross-section of the charging cable in a single row after the other in the first extension direction.

Advantageously, the first wire group comprises a portion of the energy wires, in particular three energy wires, and preferably at least one pilot wire, in particular three pilot wires. Preferably, the energy wires of the first wire group are arranged adjacent to each other in a triangular cross-section. In particular, one pilot wire is arranged on the outside between two energy wires.

Preferably, the second wire group comprises a further part of the energy wires, in particular two energy wires, and preferably at least one, in particular two pilot wires. In this case, the energy wires are arranged in the first extension direction E1 relative to one another and after the other in cross-section in a single row and preferably the pilot wires are arranged on the outside between the two energy wires in each case below and/or above in the contact region of the energy wires.

Preferably, the second wire group comprises a further part of the energy wires, in particular two energy wires, and preferably at least one, in particular two pilot wires. In this case, the energy wires are arranged in the first extension direction E1 relative to one another and after the other in cross-section in a single row and preferably the pilot wires are arranged on the outside between the two energy wires in each case below and/or above in the contact region of the energy wires.

By separating the current-carrying energy wires into two groups, mutual heating is reduced. The free surface of the energy wires is increased, which means better heat dissipation from the charging cable. This also simplifies the separation of energy wires.

Preferably, the charging cable is constructed without separate separation aids, such as talcum powder, on the insulation layer of the cables. This is possible in particular due to the foamed layer, as it adheres less strongly to the wires.

The electrical charging cable is preferably connected electrically and mechanically at at least one end to a plug-in coupling part for releasable connection to a compatible plug-in coupling part of an electric vehicle and at the other end either directly connected to a charging station in a non-releasable manner electrically and mechanically or also connected electrically and mechanically to a plug-in coupling part for releasable connection to a compatible plug-in coupling part of a charging station.

### BRIEF DESCRIPTION OF THE DRAWINGS

Further advantageous embodiments of the invention are shown in the following description of the figures and the dependent subclaims.

It shows:

FIG. 1 is a cross-section through a first embodiment of a charging cable according to the invention with three energy wires and two pilot wires,

FIG. 2a is a cross-section through a second embodiment of a charging cable according to the invention with three energy wires and one pilot wire,

FIG. 2ba is a cross-section through a first alternative to the second embodiment according to FIG. 2a without an additional outer layer,

FIG. 2c is a cross-section through a second alternative to the second embodiment according to FIG. 2a with a foamed outer layer,

FIG. 3 is a cross-section through a third embodiment of a charging cable according to the invention with three energy wires and two pilot wires,

FIG. 4 is a cross-section through a fourth embodiment of a charging cable according to the invention with three energy wires and one pilot wire,

FIG. 5a is a cross-section through a fifth embodiment of a charging cable according to the invention with five energy wires and two pilot wires,

FIG. 5b is a cross-section through a further embodiment according to the fifth embodiment according to FIG. 5a with five energy wires and five pilot wires,

FIG. 5c is a cross-section through a further embodiment according to the fifth embodiment according to FIG. 5a with five energy wires and one pilot wire,

FIG. 6 is a cross-section through a sixth embodiment of a charging cable according to the invention with five energy wires and two pilot wires,

FIG. 7 is a cross-section through a seventh embodiment of a charging cable according to the invention with five energy wires and two pilot wires, and

FIG. 8 is a cross-section through an eighth embodiment of a charging cable according to the invention with five energy wires and two pilot wires.

### DETAILED DESCRIPTION

With regard to the following description of the figures, it is claimed that the invention is not limited to the embodiment examples and thereby not limited to all or several features of described feature combinations, rather each individual partial feature of the/each embodiment example is also of significance for the object of the invention independently of all other partial features described in connection therewith and also in combination with any features of another embodiment example.

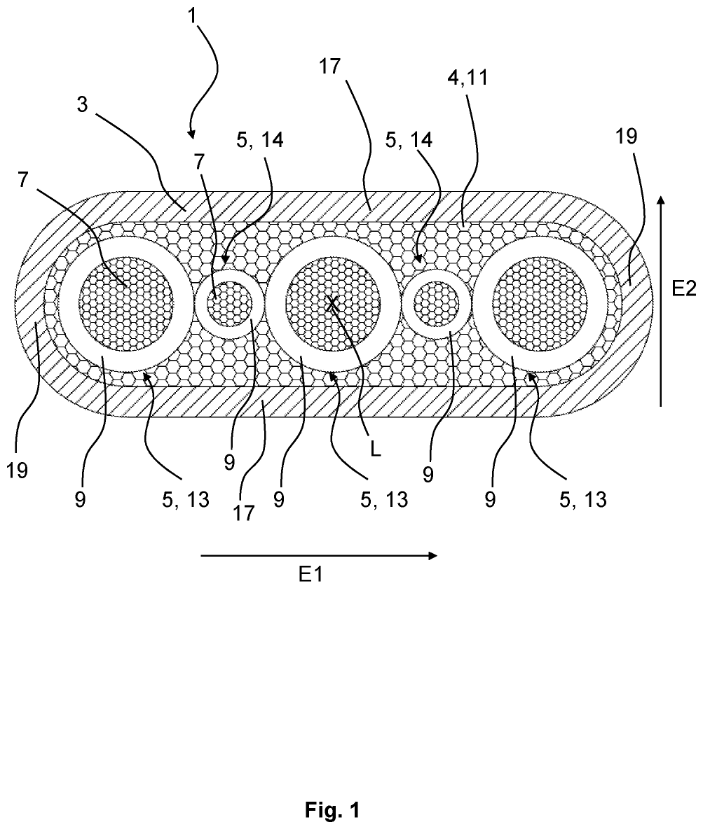

FIG. 1 shows a cross-section of a first embodiment of an electrical charging cable 1 according to the invention. The charging cable 1 comprises an outer layer 3 consisting in particular of plastic material. Five wires 5 are arranged in the outer layer 3. The wires 5 each comprise several metallic electrical conductors 7 for electrical transmission. Each of the wires 5 comprises its own electrical insulation layer 9 surrounded by the electrical conductors 7.

At least one inner layer 4, formed as a foamed layer 11, is arranged between the outer layer 3 and the wires 5. Of the wires 5, three wires 5 are formed as energy wires 13 for transmitting a charging current between the charging station and the electric vehicle and two of the wires 5 are formed as pilot wires 14 for transmitting data or signals between the charging station and the electric vehicle. The pilot wires 14 are formed with a smaller cross-section than the energy wires 13. The wires 5 are arranged in the cross-section of the charging cable 1 in a single row after the other in the first extension direction E1. A pilot wire 14 is arranged between two energy wires 13, so that the maximum width of the charging cable 1 in the first extension direction E1 perpendicular to the cable axis L is formed larger than the average height in the second extension direction E2 perpendicular to the first extension direction E1 and to the cable axis L.

The outer layer 3 has a homogeneous thickness and is formed in the shape of a strip. For this purpose, the outer layer 3 comprises two opposite straight regions 17 extending in the first extension direction E1, which are each connected at the ends to the opposite end of the other straight region 17 via an annular region 19. The radius of the annular region 19 is aligned with the outer diameter of the wire 5 arranged at the end, in particular the energy wire 13, in such a way that a gap with a constant mean height is formed between the annular region 19 and the wire 5. The inner layer 4, formed as a foamed layer 11, completely fills the space between the wires 5 and the outer layer 3, in particular also the gap.

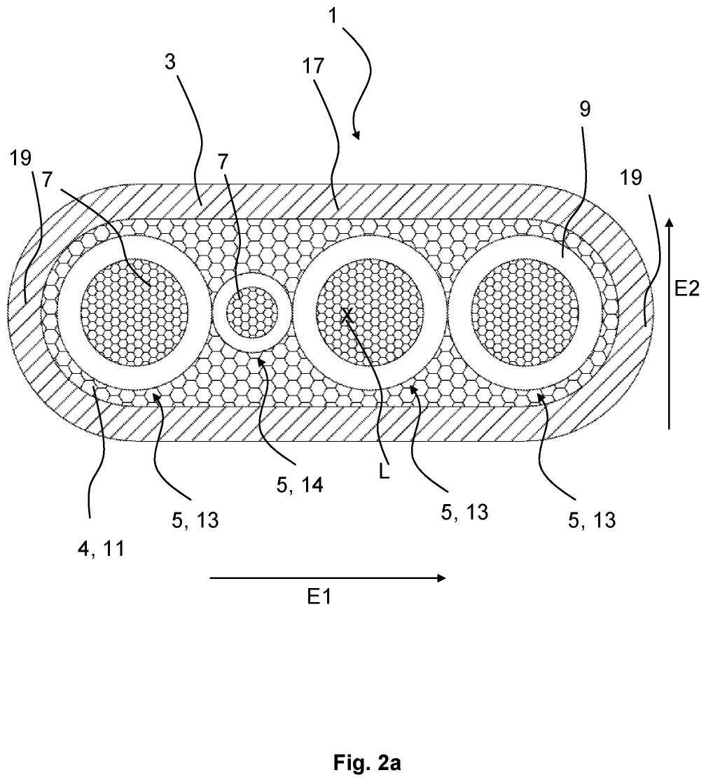

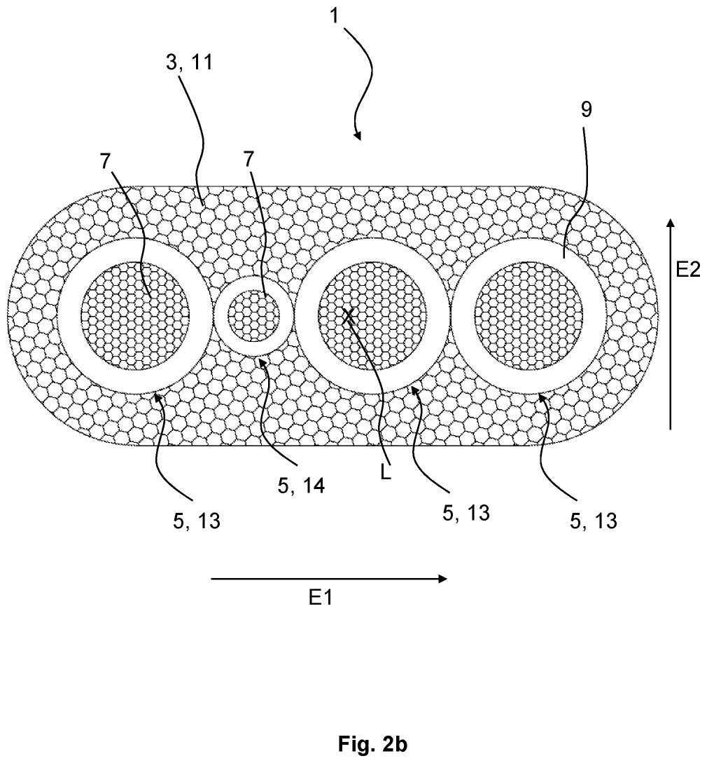

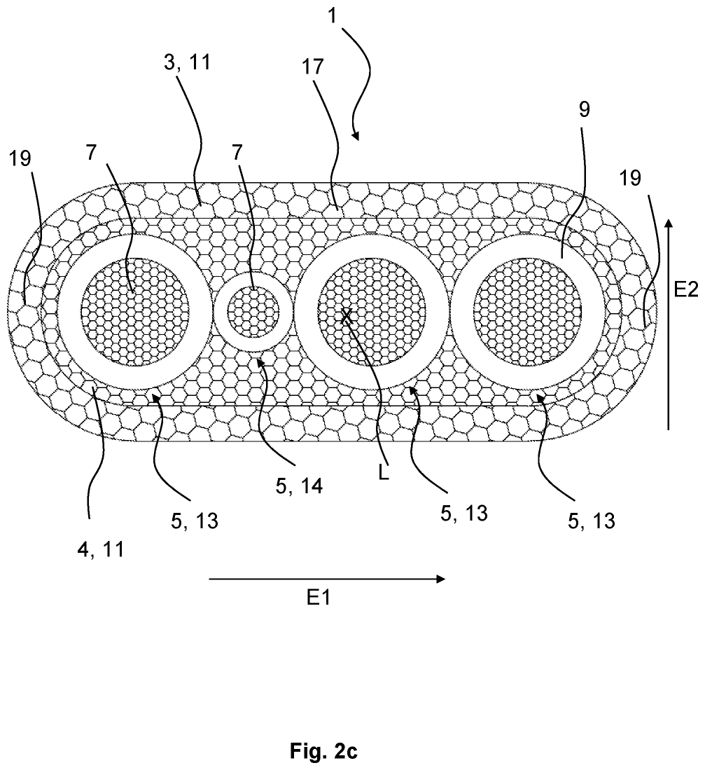

FIG. 2a shows a cross-section of a second embodiment of an electrical charging cable 1 according to the invention. The charging cable 1 according to FIG. 2 largely corresponds to the charging cable 1 according to FIG. 1. However, the charging cable 1 according to FIG. 2 comprises only a pilot wire 14.

FIG. 2b shows a cross-section of a first alternative to the second embodiment shown in FIG. 2a. The charging cable 1 according to FIG. 2b also largely corresponds to the charging cable 1 according to FIG. 1 or FIG. 2a, but the charging cable 1 according to FIG. 2b comprises only a pilot wire 14 and has only an outer layer 3 formed as a foamed layer 11 and no inner layer 4.

FIG. 2c shows a cross-section of a second alternative to the second embodiment shown in FIG. 2a. The charging cable 1 according to FIG. 2c largely corresponds to the charging cable 1 according to FIG. 1 or FIG. 2a, but the charging cable 1 according to FIG. 2c comprises only a pilot wire 14 and the outer layer 3 is also formed as a foamed layer 11 like the inner layer 4. Advantageously, the foamed layer 11 formed as inner layer 4 and the foamed layer 11 formed as outer layer 3 comprise a different specific density, wherein the difference in the specific density of the foamed layers 11 is at least 5%, preferably at least 10%. This enables optimal balancing between weight savings, tensile strength, elongation at break and other normative and technical requirements, such as wall thickness.

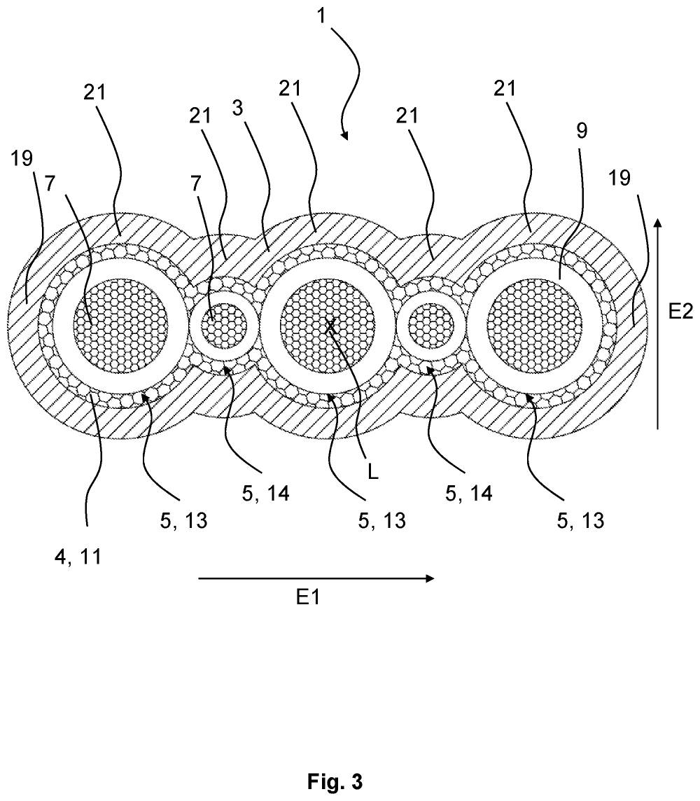

FIG. 3 shows a cross-section of a third embodiment of an electrical charging cable 1 according to the invention. The charging cable 1 according to FIG. 3 corresponds to the charging cable 1 according to FIG. 1 with regard to the wires 5. However, the design of the outer layer 3 and the inner layer 4 differs in particular.

Instead of the opposite straight regions 17 of the outer layer 3 running in the first extension direction E1 of the cross-section, the outer layer 3 has several arcuate, adjoining partial regions 21 in the first extension direction E1, the respective radius of curvature of which is aligned with the outer diameter of the wire 5 arranged in the respective partial region 21, so that the outer layer 3 runs parallel to the outer circumference of the respective wire 5, particularly in the respective partial region 21. The outer layer 3 is preferably formed differently with its thickness in the respective partial regions 21, whereby it is formed thicker in particular in the partial regions 21 of the pilot wires 14 than in the partial regions of the energy wires 13.

The respective radius of curvature of the partial regions 21 is aligned in such a way that a gap is formed between the outer layer 3 and the wires 5. The end partial regions 21 in the extension direction E1 are each connected to the respective opposite end partial regions 21 via an annular region 19. The radius of the annular region 19 is aligned with the outer diameter of the wire 5 arranged at the end, in particular the energy wire 13, in such a way that a gap is also formed between the annular region 19 and the wire 5. The gap preferably has an average constant height and is advantageously completely filled by the inner layer 4 formed as a foamed layer 11.

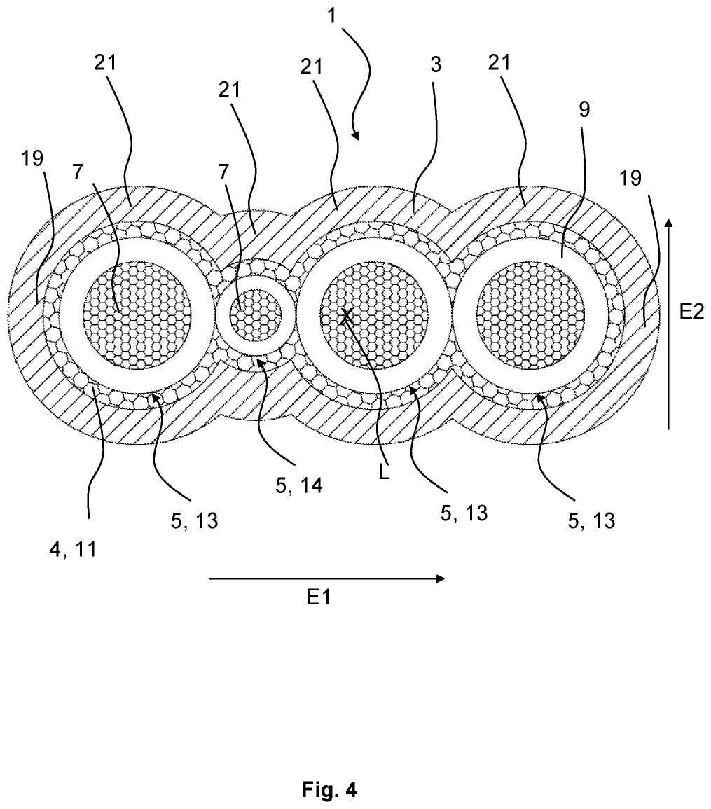

FIG. 4 shows a cross-section of a fourth embodiment of an electrical charging cable 1 according to the invention. The charging cable 1 according to FIG. 4 largely corresponds to the charging cable 1 according to FIG. 3. However, the charging cable 1 according to FIG. 4 comprises only a pilot wire 14.

In the embodiments according to FIG. 1 to FIG. 4, all wires 5 in particular are arranged in such a way that their central axes lie in a common plane perpendicular to the cable axis L and extending along the first extension direction E1. In addition, in these embodiments, the wires 5 are advantageously arranged relative to one another in such a way that the insulation layers 9 of the wires 5 adjacent to one another are in direct contact with one another or touch at least at one point on the outer circumference of the insulation layers 9.

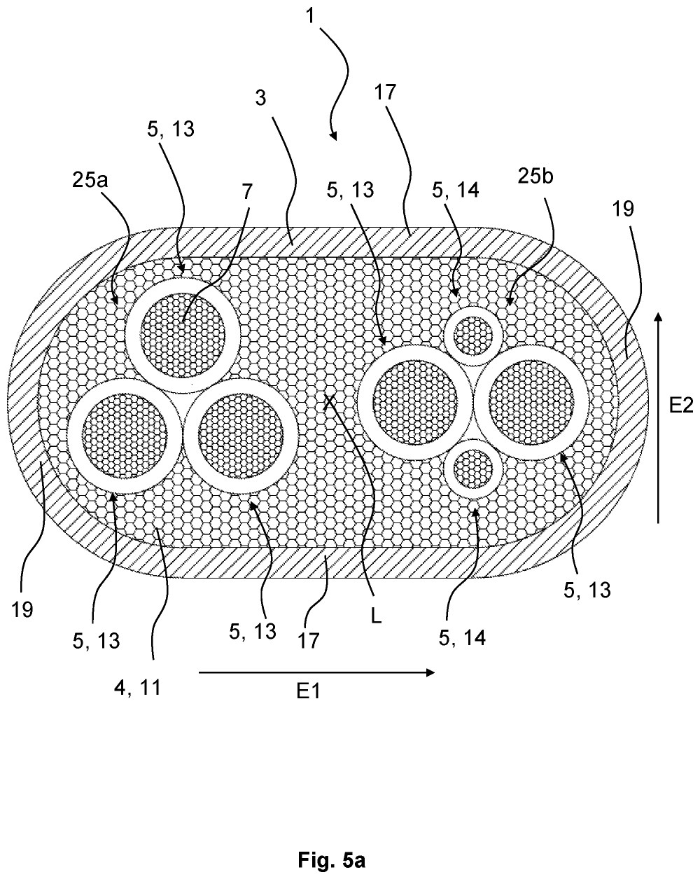

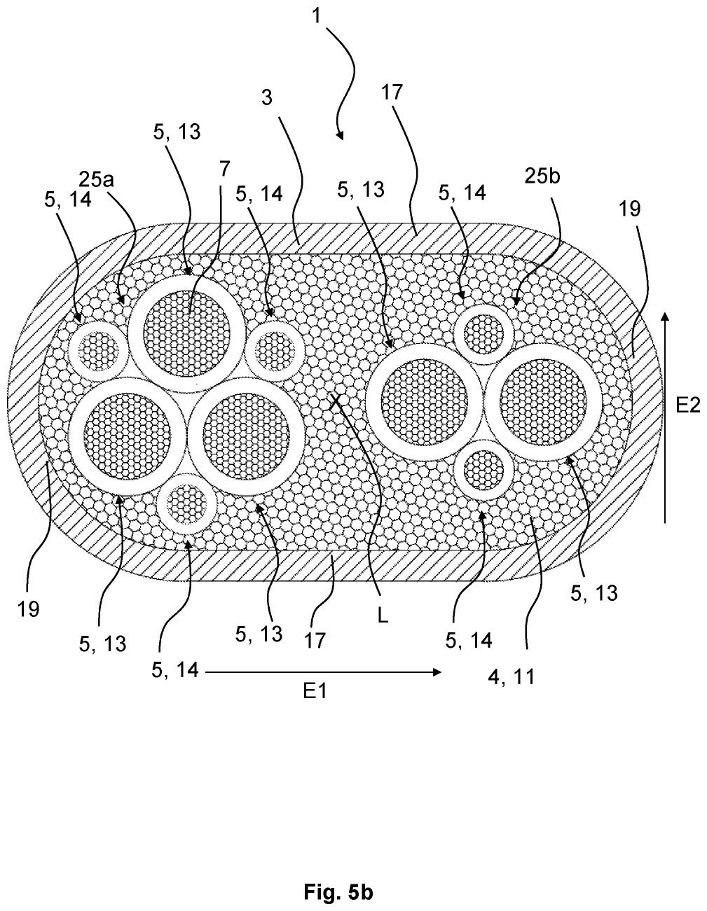

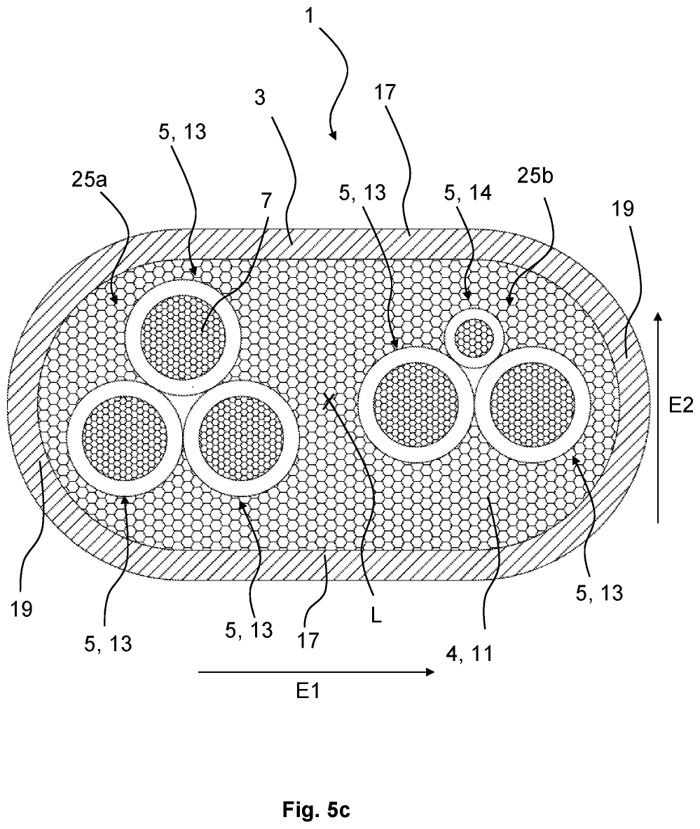

FIG. 5 (FIG. 5a. FIG. 5b, FIG. 5c) shows a cross-section of a fifth embodiment of an electrical charging cable 1 according to the invention. The charging cable 1 comprises an outer layer 3 made of plastic material. Six, seven or ten wires 5 are arranged in the outer layer 3. The wires 5 each comprise several metallic electrical conductors 7 for electrical transmission. Each of the wires 5 comprises its own electrical insulation layer 9 surrounded by the electrical conductors 7. At least one inner layer 4 formed as a foamed layer 11 is arranged between the outer layer 3 and the wires 5. Of the wires 5, five wires 5 are formed as energy wires 13 for transmitting a charging current between the charging station and the electric vehicle and one, two or five of the wires 5 are formed as pilot wires 14 for transmitting data or signals between the charging station and the electric vehicle.

The wires 5 are divided into two wire groups 25a, 25b, in particular stranded separately from each other. The wire groups 25a, 25b are arranged parallel to one another and in the cross-section of the charging cable 1 in a single row after the other in the first extension direction E1.

The first wire group 25a comprises three energy wires 13, the energy wires 13 being arranged in a triangular cross-section.

The second wire group 25b comprises two energy wires 13 and one or two pilot wires 14, the energy wires 13 being arranged in a row after the other in cross-section in the first extension direction E1 and the pilot wires 14 being arranged on the outside between the two energy wires 13, in each case below and above in the contact region of the energy wires 13.

Due to the division into the two wire groups 25a. 25b and the special arrangement of the wire groups 25a and 25b, the maximum width of the charging cable 1 in the first extension direction E1 perpendicular to the cable axis L is formed larger than the maximum height in the second extension direction E2 perpendicular to the first extension direction E1 and to the cable axis L.

The outer layer 3 according to FIG. 5 is, as in the embodiment according to FIG. 1 and FIG. 2, formed in the shape of a strip and has a homogeneous thickness. For this purpose, the outer layer 3 comprises two opposite straight regions 17 extending in the first extension direction E1, which are each connected at the ends to the opposite end of the other straight region 17 via an annular region 19. The radius of the annular regions 19 is aligned with the outer diameter of the wire groups 25a, 25b, in particular the wire group 25a, 25b with the larger outer diameter, in such a way that a gap is formed between the annular region 19 and the wires 5 or pilot wires 14 of the wire groups 25a, 25b. The inner layer 4, formed as a foamed layer 11, completely fills the space between the wire groups 25a, 25b and the outer layer 3, in particular the gap.

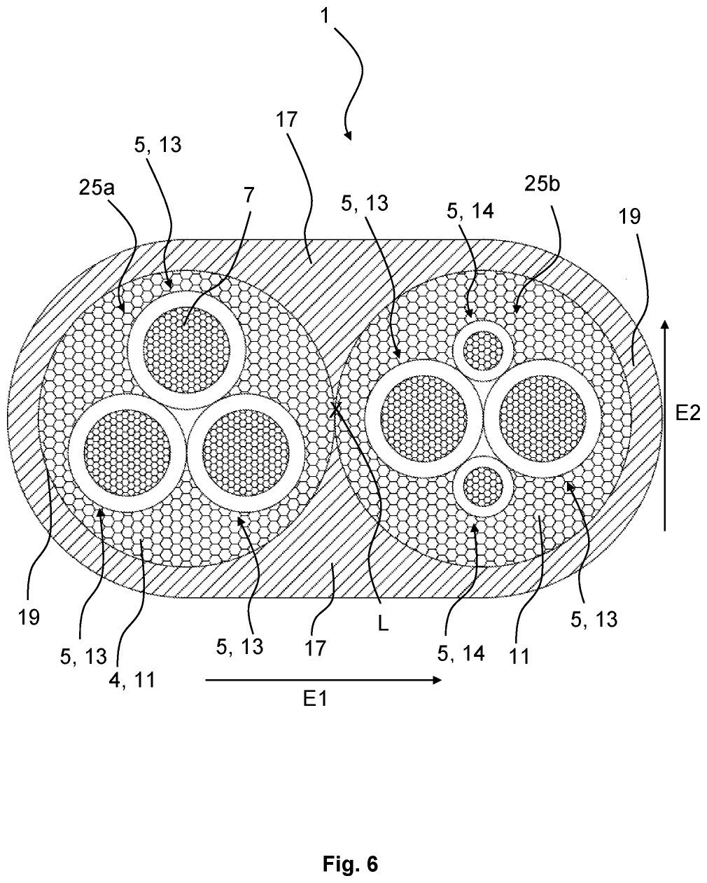

FIG. 6 shows a cross-section of a sixth embodiment of an electrical charging cable 1 according to the invention. The charging cable 1 according to FIG. 6 corresponds to the charging cable 1 according to FIG. 5 with regard to the wires 5 and the wire groups 25a, 25b. However, the design of the outer layer 3 and the inner layer 4 formed as a foamed layer 11 differs in particular.

According to the embodiment in FIG. 6, the inner layer 4 formed as a foamed layer 11 encases the two wire groups 25a, 25b in a circular cross-section, so that a separate circular encasement is formed for each wire group 25a, 25b, which are formed tangentially adjacent to each other.

The outer layer 3 comprises two opposite regions 17 which extend in the first extension direction E1 and are straight on the outside, which project pointedly on the inside into the contact region in the direction of the cable axis L between the two circular encasements of the wire groups 25a. 25b and completely fill the space between the circular encasements of the wire groups 25a, 25b.

The two regions 17 of the outer layer 3, which are straight on the outside, are each connected at the ends to the opposite end of the other region 17, which is straight on the outside, via an annular region 19. The radius of the annular regions 19 is aligned with the outer diameter of the circular encasements of the wire groups 25a, 25b formed by the foamed layer 11.

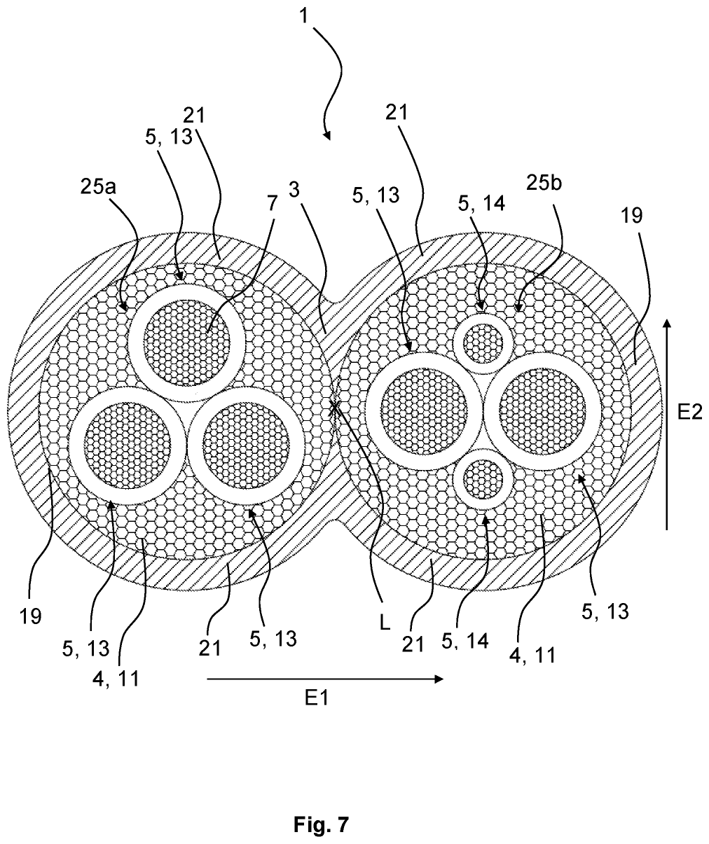

FIG. 7 shows a cross-section of a seventh embodiment of an electrical charging cable 1 according to the invention. The charging cable 1 according to FIG. 7 corresponds to the charging cable 1 according to FIG. 6 with regard to the wires 5, the wire groups 25a, 25b and the inner layer 4 formed as a foamed layer 11 with the two encases of the wire groups 25a, 25b. However, the design of the outer layer 3 in particular differs. Instead of the straight regions 17 on the outside, the outer layer 3 comprises two curved partial regions 21 on the upper and lower sides, the curvature of which is aligned with the outer radius of the encases of the wire groups 25a, 25b formed by the foamed layer 11. The thickness of the outer layer 3 and in particular of the annular regions 19 and the partial regions 21 is homogeneous except for the ends of the partial regions 21 in the contact region of the two encases.

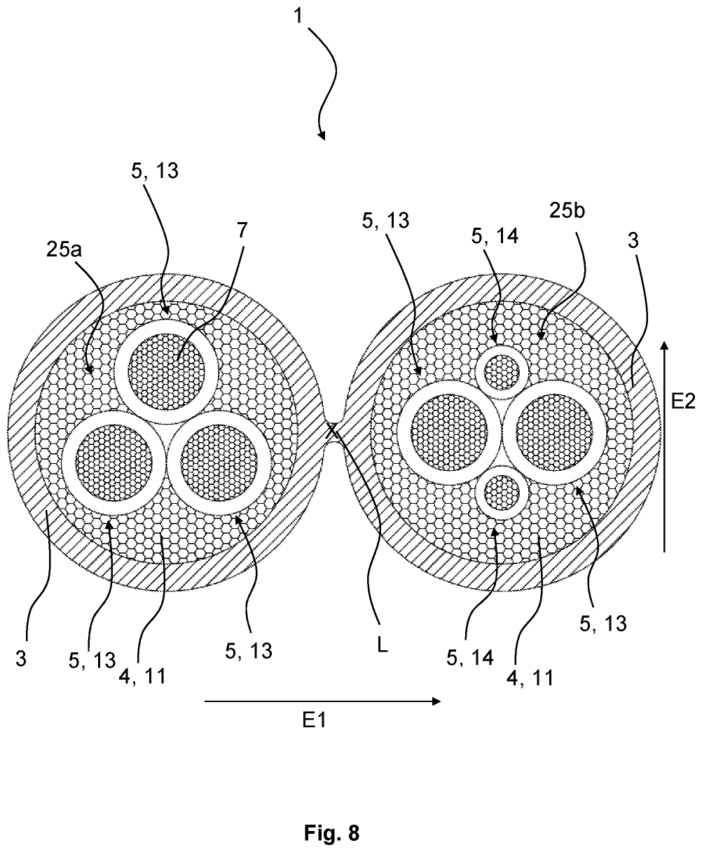

FIG. 8 shows a cross-section of an eighth embodiment of an electrical charging cable 1 according to the invention. The charging cable 1 according to FIG. 8 corresponds to the charging cable 1 according to FIG. 6 and FIG. 7 with regard to the wires 5 and the wire groups 25a, 25b. However, the design of the outer layer 3 and the inner layer 4 formed as a foamed layer 11 with the two encasings of the wire groups 25a, 25b of the charging cable 1 differs in particular. Instead of the straight regions 17 on the outside as shown in FIG. 6 or the curved partial regions as shown in FIG. 7, the outer layer 3 encases the two sheaths of the wire groups 25a, 25b formed by the foamed layer 11 completely and also circularly with a constant average thickness. In this case, the two encasements formed by the foamed layer 11 are spaced apart from each other by the outer layer 3 lying between them, with the outer layer 3 forming a connecting web 27 between the two encasements formed by the foamed layer 11.

In the embodiments according to FIG. 5 (FIG. 5a, FIG. 5b, FIG. 5c), FIG. 6, FIG. 7 and FIG. 8, the wire groups 25a, 25b in particular are arranged in such a way that their central axes lie in a common plane perpendicular to the cable axis L and extending along the first extension direction E1. In addition, in these embodiments, the wires 5 of a wire group 25a, 25b are advantageously arranged relative to one another in such a way that the insulation layers 9 of the wires 5 adjacent to one another are in direct contact with one another or touch at least at one point on the outer circumference of the insulation layers 9.

In particular, the electrical insulating sheath of the electrical charging cable 1 consists of the foamed layer 11 (see FIG. 2b) or of two foamed layers 11 (see FIG. 2c) or of the outer layer 3 and the foamed layer 11 formed as inner layer 4 (see FIGS. 1, 2a, 3, 4, 5a, 5b, 5c, 6, 7, 8).

Particularly advantageously, the electrical charging cable 1 does not comprise a shielding layer or shielding sheath that acts as electromagnetic shielding, in particular comprising a metallic material. This enables a particularly compact, lightweight and flexible design.

The invention is not limited to the embodiments shown and described, but also comprises all embodiments having the same effect in the sense of the invention. In particular, the number of energy wires 13 and/or pilot wires 14 may vary or other wires, cooling elements or support elements may be added. Moreover, in all embodiments, the outer layer 3 may also be formed as a foamed layer 11. It is expressly emphasized that the embodiment examples are not limited to all features in combination, rather each individual sub-feature can also have an inventive significance in itself, detached from all other sub-features. Furthermore, the invention is not yet limited to the combination of features defined in claim 1, but can also be defined by any other combination of certain features of all the individual features disclosed. This means that, in principle, practically any individual feature of claim 1 can be omitted or replaced by at least one individual feature disclosed elsewhere in the application.

1. An electrical charging cable for connecting a charging station to an electric vehicle, the electrical charging cable comprising:
an electrically insulating sheath including a plastic material, at least three wires arranged in the sheath, each having at least one electrical conductor and an insulating layer, the sheath having at least one foamed layer, wherein
a maximum width of the charging cable in a first extension direction running perpendicular to the cable axis is formed larger than a maximum height in a second extension direction running perpendicular to the first extension direction and to the cable axis.

2. The electrical charging cable according to claim 1, wherein
the sheath has at least two layers, an outer layer and an inner layer surrounded by the outer layer, and the foamed layer forms the outer layer and/or the inner layer.

3. The electrical charging cable according to claim 1, wherein
two foamed layers have a different specific density, the difference in the specific density of the foamed layers being at least 5%, preferably at least 10%.

4. The electrical charging cable according to claim 1, wherein
the foamed layer forms at least the inner layer.

5. The electrical charging cable according to claim 1, wherein
the foamed layer directly surrounds an outer insulation layer of the wire.

6. The electrical charging cable according to claim 1, wherein
the maximum width of the charging cable in the first extension direction is at least 1.5 times larger than the maximum height of the charging cable in the second extension direction.

7. The electrical charging cable according to claim 1, wherein
the wires run parallel to one another in the first extension direction and are arranged in cross-section in a single row after the other.

8. The electrical charging cable according to claim 1, wherein
the wires are divided into at least two, in particular stranded wire groups, and the wire groups run parallel to one another in the first extension direction and are arranged in cross-section in a single row after the other.

9. The electrical charging cable according to claim 1, wherein
at least three of the wires are formed as energy wires and at least one wire is formed as a pilot wire in the charging cable.

10. The electrical charging cable according to claim 1, wherein
five energy wires and two pilot wires are formed in the charging cable.

11. The electrical charging cable according to claim 9, wherein
the pilot wire is arranged in the cross-section in a clearance between the energy wires arranged in a row.

12. The electrical charging cable according to claim 1, wherein
the outer layer has two opposite straight regions extending in the first extension direction, which are each connected at the ends via an annular region to the opposite end of the other straight region.

13. The electrical charging cable according to claim 1, wherein
the outer layer has, in the first extension direction, a plurality of arcuate, adjoining partial regions, the respective radius of curvature of which is aligned with the outer diameter of the wires arranged in the respective partial region, so that the outer layer runs parallel to the outer circumference of the respective wire, in particular in the respective partial region.

14. The electrical charging cable according to claim 8, wherein
the outer layer has, in the first extension direction, a plurality of arcuate, adjoining partial regions, the respective radius of curvature of which is aligned with the outer diameter of the wire groups arranged in the respective partial region, so that the outer layer runs parallel to the outer circumference of the respective wire group, in particular in the respective partial region.

15. The electrical charging cable according to claim 2, wherein
the outer layer and the foamed layer are connected to each other by coextrusion or tandem extrusion.

16. The electrical charging cable according to claim 2, wherein
the sheath, in particular the outer layer and/or the foamed layer is constructed at least partly of a polyurethane, in particular a thermoplastic polyurethane.

17. The electrical charging cable according to claim 2, wherein
the sheath, in particular the outer layer and/or the foamed layer is constructed at least partly of an in particular thermoplastic polyolefin elastomer or in particular thermoplastic polyvinyl chloride.

18. The electrical charging cable according to claim 1, wherein
the wires have an outer insulation layer and are arranged relative to one another in such a way that the insulation layers of the wires adjacent to one another are in direct contact with one another.

19. The electrical charging cable according to claim 2, wherein
the electrical insulating sheath consists of the outer layer and the inner layer formed as a foamed layer.

20. The electrical charging cable according to claim 2, wherein
the electrical insulating sheath consists of the foamed layer.

21. An assembled electrical charging cable, comprising a charging cable according to claim 1 and at least one plug-in coupling part electrically connected to the charging cable at at least one end for releasable electrical connection of the charging cable to a compatible plug-in coupling part of an electric vehicle.
